(19) United States
(12) Patent Application Publication
(10) Pub. No.: US 2007/0140144 A1
(43) Pub. Date: Jun. 21, 2007

(54) Service designs for communications networks

(75) Inventors: Timothy Calvin Dadd, Windsor (GB); Louisa Charlotte Tayton, Thornbury (AU); Russell John Harrison, Camberwell (AU)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Open Telecommunications Ltd.

(21) Appl. No.: 11/314,125

(22) Filed: Dec. 21, 2005

(51) Int. Cl. H04L 12/28

(52) U.S. Cl. 370/254; 370/465

(57) ABSTRACT

The production of a service design for a communications network in response to a provisioning order is described. An order specifies a change to the network between a start node and an end node, and at least one condition attaching to that change. A design model satisfying said at least one condition is selected. The design model includes at least information on design items related to the network resource. All design permutations of the design items of the selected design model are determined. The design permutations are preferentially ranked. Each ranked design permutation is compared in turn against a network model to find a permutation matching the specified start and end nodes, the matching design permutation then becoming the service design.

### FIELD OF THE INVENTION

The invention relates to the field of telecommunications, and particularly to the design of communications networks.

### BACKGROUND OF THE INVENTION

Telecommunications networks are complex mixtures of equipment and mediums. For example, a point-to-point telephone call can pass through a local PABX, a local exchange, and a central exchange, then be routed through a separate local exchange and ultimately to the handset of the other party. Where the other party is located in another country there can be a far greater array of paths and equipment, including undersea cables and satellite links. Telecommunications networks carry many forms of ‘signals’, including voice, ATM, packet data, Internet Protocol Data and mobile telephony. The networks are constituted by wired, wireless (including RF and microwave) and fibreoptic components.

The design of such complex telecommunications networks is known as ‘provisioning’. Provisioning includes the situations of: the installation of new networks services, the rearrangement of existing network services, and the decommissioning or termination of existing network services. The output of a provisioning process—in response to a provisioning request—is a “plan”. It is desirable to automate network provisioning requests as much as possible. The ideal situation is ‘zero-touch’ provisioning, where the necessary actions are taken without any human intervention. However, this is practically not possible given the variety of equipment and infrastructure in existing networks.

A relevant de facto standard that applies for the provisioning of telecommunications network is the ITU-T M.3050 Recommendation (Enhanced Telecommunications Operations Map) published in May 2004. This Recommendation defines basic networking nomenclature, which includes:

| Term | Meaning |
|---|---|
| PDH | Plesiochronous Digital Hierarchy - a technology used in |
| | telecommunications networks to transport large quantities |
| | of data over digital transport equipment such as fibre optic |
| | and microwave radio systems |
| SDH | Synchronous Digital Hierarchy - is a standard for |
| | communicating digital information using lasers or light |
| | emitting diodes (LEDs) over optical fiber as defined by GR- |
| | 253-CORE |
| ATM | Asynchronous Transfer Mode - ATM is a connection |
| | oriented packet switching technology with guaranteed |
| | Quality of Service making use of dynamic bandwidth |
| | allocation |
| Trail | A connectivity entity (connection) responsible for the |
| | transfer of information between different Network |
| | Elements. It performs signal assembly and multiplexing |
| | function and terminates on Termination Points. |
| Subnetwork | A transport entity which is capable of transferring |
| | information between Termination Points across a sub- |
| | network. It is configured as part of trail management |
| | process. |
| Network | A single managed entity in the Network which consists of a |
| element | number of Equipment and logical Termination Points and |
| | may or may not be geographically distributed. |
| Node | Represents a physical location such as a plot of land, and |
| | houses the telecommunication network infrastructure |
| | identified with an address and geographical coordinates. |

Known provisioning strategies tend only to operate at one layer of the ISO open system interconnection reference model. Such solutions have the drawback of not taking into account customer service levels or business rules relating to the network's operation.

Additionally, it is inevitably the case that provisioning requests must, in practise, cope with multi-layer, multi-technology solutions to provisioning the network.

It is the object of the present invention to overcome or substantially ameliorate at least one of the above disadvantages.

### SUMMARY OF THE INVENTION

In accordance with one aspect, there is provided a method for producing a service design for a communications network in response to a provisioning order specifying a change to the network between a start node and an end node and at least one condition attaching to that change, the method comprising the steps of:

selecting a design model satisfying said at least one condition, the design model including at least information on design items related to the network resources;

determining all design permutations of the design items of the selected design model;

preferentially ranking the design permutations; and

comparing each ranked design permutation in turn against a network model to find a permutation matching the specified start and end nodes, the matching design permutation then becoming the service design.

In accordance with another aspect, there is provided a computer system for producing a service design for a communications network in response to a provisioning order specifying a change to the network between a start node and an end node and at least one condition attaching to that change, the system comprising:

a memory store storing a plurality of design model; and

a processor to select a said design model satisfying said at least one condition, the design model including at least information on design items related to the network resources, determine all design permutations of the design items of the selected design model, preferentially rank the design permutations, and compare each ranked design permutation in turn against a network model to find a permutation matching the specified start and end nodes, the matching design permutation then becoming the service design.

Preferably, the comparing step selects the first matching design permutation. The permutations can be ranked according to the decision points in each design item. Furthermore, the ranking can be performed by an explode sequence operation and sequential ordering of permutations as they arise during said explode sequence operation. Design permutations that do not satisfy predetermined network rules can be excluded.

Advantageously, the design model exists within a set of predetermined such models.

Also, there can be the further step of comparing the matching design permutation against capacity of the network, and accepting the matching design permutation as the service design only if the network capacity is not exceeded.

A computer program product is also disclosed.

### BRIEF DESCRIPTION OF THE DRAWINGS

A preferred form of the present invention will now be described by way of example with reference to the accompanying drawings wherein:

FIG. 1 is a schematic block diagram of a representative network architecture.

FIG. 2 is a schematic block diagram of a system for producing Design Models.

FIG. 3 is a block flow diagram of the production of a service design in broad terms.

FIG. 4 is a block flow diagram of the development of a set of product models.

FIG. 5 shows an example product model.

FIG. 6 is a block flow diagram of an embodiment of the production of a service design.

FIG. 7 is a schematic block diagram of a computer hardware platform on which an embodiment can be implemented.

### DETAILED DESCRIPTION OF THE PREFERRED EMBODIMENTS

In this description, the following terms take the meaning given:
Design Product Represents the engineering rules for designing a service. Contains one or more Design Models.
Design Model One way of designing the service end-to-end, as a list of Design Items.
Design Item A placeholder that will become a component in the resulting service design. The Design Item is a set of selection criteria for finding a suitable network resource.
Product Model A suite of design products, design models and design items that describe the design of the service. There can be one or more such Product Models.

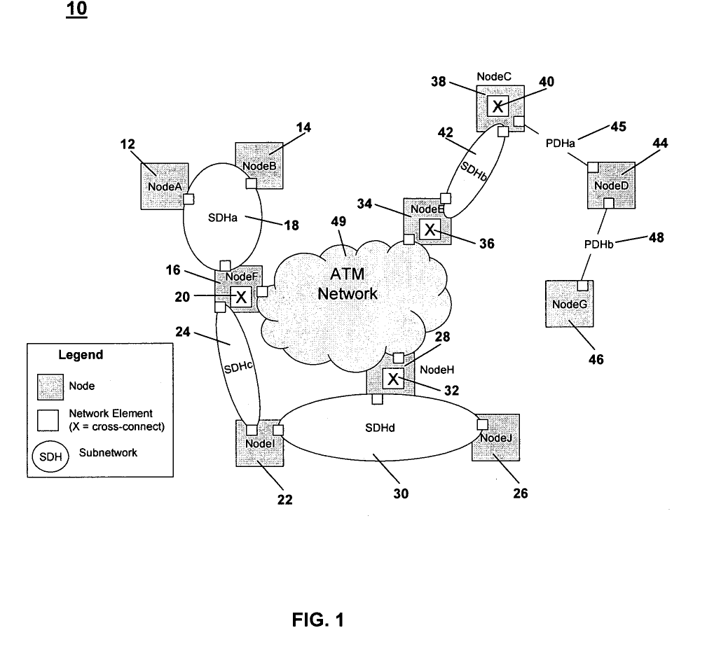

FIG. 1 is a generalised, representative network architecture 10 including discrete networks, network elements and nodes. Specifically, NodeA 12, NodeB 14 and NodeF 16 are interconnected by sub-network SDHa 18. NodeF 16 includes a cross-connect 20 linking networks common to NodeF 16. NodeI 22 is interconnected with NodeF 16 by the sub-network SDHc 24. Nodel 22, NodeJ 26 and Node H 28 are interconnected by the sub-network SDHd 30. NodeH 28 also include a cross-connect 32. NodeE 34, which includes a cross-connect 36, and NodeC 38, which also includes a cross-connect 40, are interconnected by the sub-network SDHb 42. NodeD 44 is connected with NodeD 44 by the link PDHa 45. NodeD 44 is also connected with NodeG 46 by the link PDHb 48. The cross-connects 20, 28, 36 provide connectivity to the ATM network 49.

A trail can be formed between any one of the nodes 12, 14, 16, 22, 26, 28, 34, 38, 44, 47, passing through one or more of the ATM network 48 and the sub-networks 18, 24, 30, 42 or the links 45, 48. In a typical actual network, the number of nodes can be in the tens of thousands, the number of sub-networks can be in the thousands and the number of networks can be in the tens.

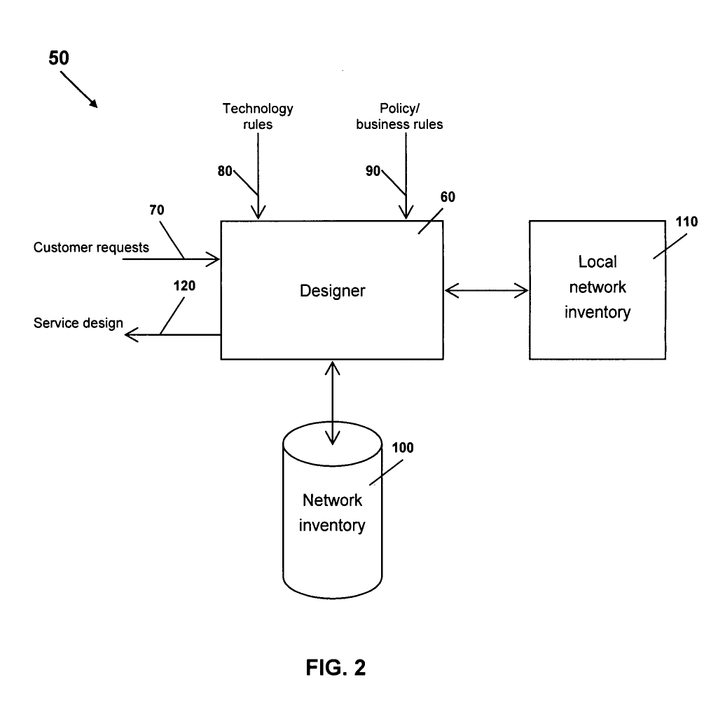

FIG. 2 is a schematic block diagram of a system 50 for generating service designs. A designer module 60 receives customer requests 70 that will relate to a request for a new network service, for a rearranged network service or for the termination of a network service. The designer module 60 also receives as inputs technology rules 80 and policy/business rules 90. Additionally, a detailed network inventory 100 is available to the designer module 60. A limited, abstracted form of the total network inventory 100 is stored locally in a local network inventory 110.

In processing customer requests 70, the designer module 60 takes into account the technology rules 80 policy/business rules 90 and the local network inventory 110 information, and generates a service design 120 as the output. The service design 120 represents a plan of how to configure services in the network in the satisfaction to the customer requests.

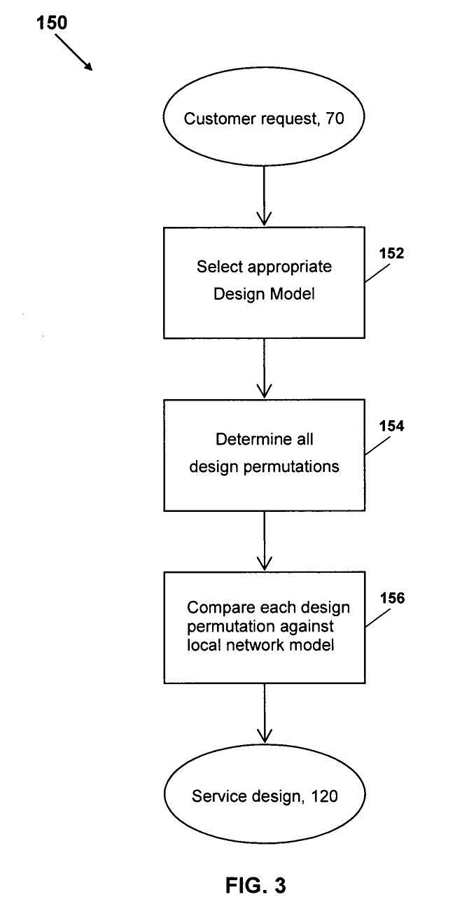

FIG. 3 is a block flow diagram 150 describing, in broad terms, how the customer requests 70 are handled to generate the resultant service design 120. At block 152, a customer request is received and the appropriate Design Model for the customer request is selected. At block 154 all the design permutations for the selected Design Model are determined. At block 156, each design permutation is compared against a local network model, and one permutation is chosen to generate the service design 120.

The network inventory 100 holds data describing the network 10. The designer module 60 requests the following data from the inventory 100:
A list of all nodes (for initial population of the local inventory 110)
A list of all subnetworks and trails (also for initial population)
A list of all network elements in a subnetwork (also for initial population)
Capacity availability on a subnetwork or trail
To reserve capacity on a subnetwork or trail

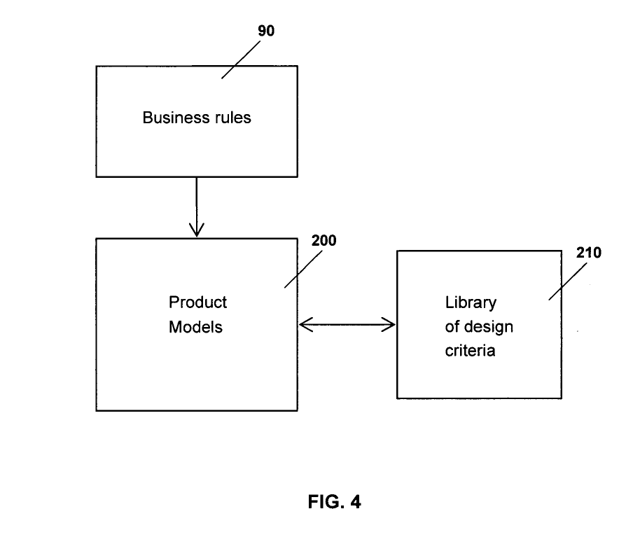

As shown in FIG. 4, a set of Product Models 200 are developed by applying a set of given business rules 90 to a library of design criteria 210. The criteria include lists of network element types, trail types, termination point types, and so on. The Design Product is an abstraction of the standard form(s) of a trail for a given purpose. Each Design Product may have several Design Models, which represent alternative ways to compose the trail. Each Design Model consists of a set of Design Items. A Design Item is a set of selection criteria for finding an appropriate network resource, and can also be thought of as a placeholder that will become a component in the resulting service design. A Design Item may encapsulate another Design Product, allowing different alternatives to be considered for subsections of the overall design.

Product Model

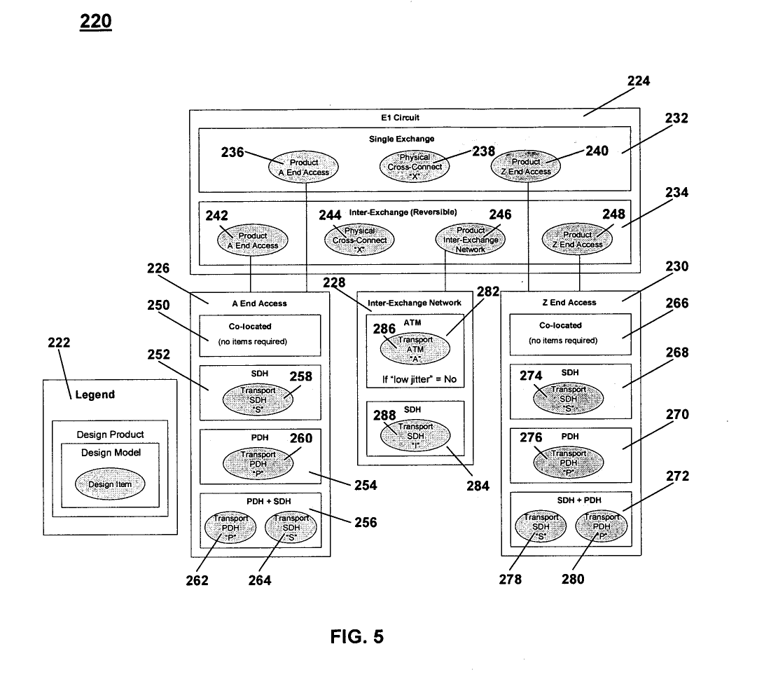

FIG. 5 shows an example Product Model 220. The legend 222 shows the relationship between a Design Product, a Design Model and a Design Item. Unless otherwise mentioned, each Design Item allows only one repeat.

The example Product Model 220 builds an E1 (2 Mbit/s) trail between two given nodes. There are four Design Products: the E1 Circuit 224, the A End Access 226, the Inter-Exchange Network 228 and the Z End Access 230.

The E1 Circuit 224 Design Product holds two Design Models: Single Exchange 232 and Inter-Exchange 234. Within the Single Exchange model 232, there are three Design Items: Product A End Access 236, Physical Cross-Connect ‘X’ 238 and Product Z End Access 240. Within the Inter-Exchange (Reversible) model 234 are four Design Items: Product A End Access 242, Physical Cross-Connect ‘X” 244, Product Inter-Exchange Network 246 and Product Z End Access 248.

The A End Access Design Product 226 holds three Design Models: Co-located 250, SDH 252, PDH 254 and PDH+SDH 256. The respective Design Items are: Transport SDH ‘S’ 258, Transport PDH ‘P’ 260, Transport PDH ‘P’ 262 and Transport PDH ‘S’ 264.

The Z End Access Design Product 230 has matching Design Products 266-272, and Design Items 274-280.

The Inter-Exchange Network Design Product 238 has two Design Models: ATM 282 and SDH 284, within each respectively is a single Design Item: Transport ATM ‘A’ 286 and SDH 288. The latter design item SDH allows up to three repeats.

Note that the Design Product A End Access 226 has an association with the two Design Items Product A End Access 236, 242. In a similar way, the Design Product Inter-Exchange Network 238 has an association with the Design Item Product Inter-Exchange Network 246, and the Design Product Z End Access 230 has associations with the Design Items Product Z End Access 240, 248.

Business Rules

The example business rules 90 embodied in this Design Product 220 are as follows:
Use ATM network in preference to inter-exchange SDH infrastructure
ATM may not be used if customer requires low-jitter circuit
PDH may only be used as the end link to the customer site
Trail must pass through at least one cross-connect NE, for law enforcement monitoring

### Network Inventory

The following tables show an example of the local network inventory 110.

TABLE 1
Nodes

| Node Code | Hubbing Level |
|---|---|
| NodeA | Local Exchange |
| NodeB | Periphery |
| NodeC | Local Exchange |
| NodeD | Periphery |
| NodeE | Main Exchange |
| NodeF | Main Exchange |
| NodeG | Periphery |
| NodeH | Main Exchange |
| NodeI | Local Exchange |
| NodeJ | Periphery |

TABLE 2
Network Elements

| Node Code | Name | Type |
|---|---|---|
| NodeA | NodeA_SDH1 | SDH Add-Drop Multiplexer |
| NodeB | NodeB_SDH1 | SDH Add-Drop Multiplexer |
| NodeC | NodeC_SDH1 | SDH Add-Drop Multiplexer |
| NodeC | NodeC_PDH1 | PDH Multiplexer |
| NodeC | NodeC_XC1 | Cross-connect |
| NodeD | NodeD_PDH1 | PDH Multiplexer |
| NodeD | NodeD_PDH2 | PDH Multiplexer |
| NodeE | NodeE_SDH1 | SDH Add-Drop Multiplexer |
| NodeE | NodeE_ATM1 | ATM Edge Switch |
| NodeE | NodeE_XC1 | Cross-connect |
| NodeF | NodeF_SDH1 | SDH Add-Drop Multiplexer |
| NodeF | NodeF_SDH2 | SDH Add-Drop Multiplexer |
| NodeF | NodeF_ATM1 | ATM Edge Switch |
| NodeF | NodeF_XC1 | Cross-connect |
| NodeG | NodeG_PDH1 | PDH Multiplexer |
| NodeH | NodeH_ATM1 | ATM Edge Switch |
| NodeH | NodeH_SDH1 | SDH Add-Drop Multiplexer |
| NodeH | NodeH_XC1 | Cross-connect |
| NodeI | NodeI_SDH1 | SDH Add-Drop Multiplexer |
| NodeI | NodeI_SDH2 | SDH Add-Drop Multiplexer |
| NodeJ | NodeJ_SDH1 | SDH Add-Drop Multiplexer |

TABLE 3
Bearer Systems

| Name | Technology | Standalone |
|---|---|---|
| SDHa | SDH | False |
| SDHb | SDH | False |
| SDHc | SDH | False |
| SDHd | SDH | False |
| PDHa | PDH | True |
| PDHb | PDH | True |
| ATM | ATM | False |

TABLE 4
Bearer System Pathing Points

| Bearer System | Pathing Point |
|---|---|
| SDHa | NodeA_SDH1 |
| SDHa | NodeB_SDH1 |
| SDHa | NodeF_SDH1 |
| SDHb | NodeC_SDH1 |
| SDHb | NodeE_SDH1 |
| SDHc | NodeF_SDH2 |
| SDHc | NodeI_SDH1 |
| SDHd | NodeH_SDH1 |
| SDHd | NodeI_SDH2 |
| SDHd | NodeJ_SDH1 |
| PDHa | NodeC_PDH1 |
| PDHa | NodeD_PDH1 |
| PDHb | NodeD_PDH2 |
| PDHb | NodeG_PDH2 |
| ATM | NodeE_ATM1 |
| ATM | NodeF_ATM1 |
| ATM | NodeH_ATM1 |

Producing a Service Design

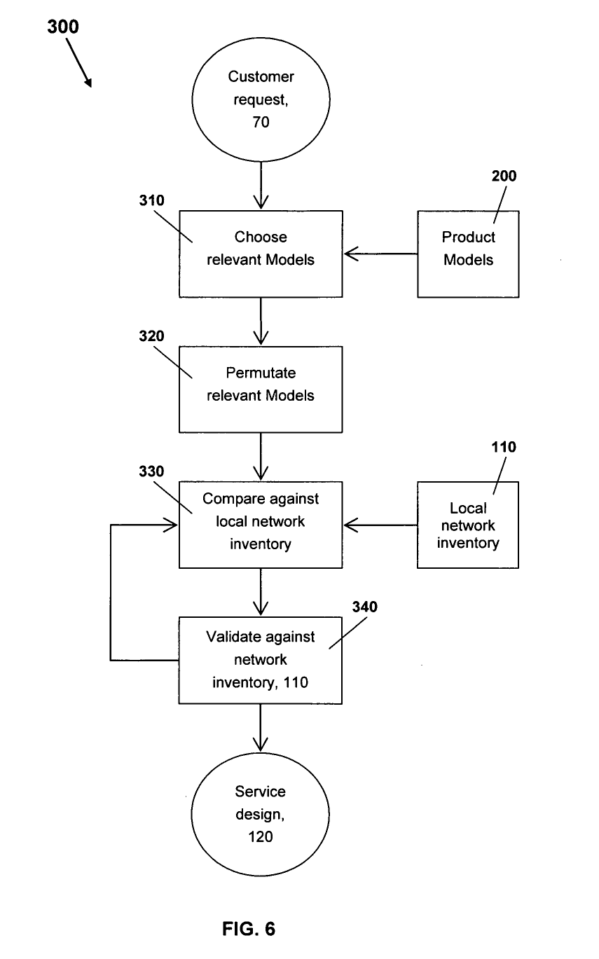

Referring now to FIG. 6, a block flow diagram 300 describes an embodiment of producing a service design for a telecommunications network structure. The example customer request 70 is to use Design Product “El Circuit” with starting node “NodeB” and ending node “Nodel” and the condition that “low jitter”=“Yes”. At block 310, the customer request 70 is considered, and with reference to the Product Models 200, the relevant subset of such Models is chosen. Note that the “ATM” model 282 in the “Inter-Exchange Network” Design Product 228 has a condition that “low jitter”=No. Because the customer has chosen “Yes” for this service design parameter, this example Product Model 220 fails the condition, and may not be used for this service design. That is, the underlying test for whether a Product Model is a candidate for a valid service design is that all the customer request conditions are met.

At block 320, the permutations of Design Items for each chosen relevant Product Model are determined. Where Design Products are nested, then the permutations of the outer Design Product represent the “most significant” variable in the permutations. Where permutations are not nested but instead are “side by side” within a Design Model, the permutations are evaluated in a ranking order to ensure that the most preferable permutations are evaluated first. In this situation a permutation can be considered as a vector [p₁ p₂ p₃ . . . ] of the indices of the options available for each decision point.

The order in which the permutations are evaluated is determined by an attribute “explode sequence” of each decision point (e.g., the choice of Design Models within a Design Product). The explode sequences can also be represented as a vector [e₁ e₂ e₃ . . . ] with the same number of elements as the permutations themselves.

If all the explode sequences are different, then any two permutations [x₁ x₂ x₃ . . . ] and [y₁ y₂ y₃ . . . ] can be ranked by the rule that x is preferable to y if xₙ<yₙ for the value of n with the lowest possible value of eₙ where xₙ≠yₙ. This is analogous to a motor vehicle's odometer, with the decision point having the lowest explode sequence representing the most significant digit on the odometer.

If some of the explode sequences are the same, then the permutations are ranked in a preference order. If we define f(p,a) as the sum of pₙ for values of n where eₙ=a, then x is preferable to y if f(x,a)<f(y,a) for the lowest possible value of a where f(x,a)≠f(y,a). If there is no such value of a, then the ranking is arbitrary.

Where a Design Item allows multiple repeats, individual permutations will be generated for each number of repeats of the item from 1 to the maximum allowed. Each Design Item for which multiple repeats is allowed also has an explode sequence to indicate how to order the permutations generated in the overall sequence.

The list of permutations for the example Design Product for this scenario is given in the table below. Each permutation consists of a list of Design Items. (In this list, each letter represents a Design Item.)

Assume that the explode sequence for the “A End Access” and “Z End Access” Design Products is 1 for both, and the explode sequence for the repeats of the ‘M’ design item (i.e. SDH 284 within the Inter-Exchange Network Design Model 228) is 2. As a result, the permutations need to be ranked by f(p, 1) and f(p, 2) where it exists (i.e. the permutations include the design item with explode sequence 2).

TABLE 5

| | | Permutation | | |
|---|---|---|---|---|
| | | as Decision | | |
| | Permutation | Point | f(p, | f(p, |
| | Result | indices | 1) | 2) |
| These permutations are | X | [1 1] | 2 | |
| generated by the Design | SX | [2 1] | 3 | |
| Model “Single Exchange” | XS | [1 2] | 3 | |
| 232 | SXS | [2 2] | 4 | |
| | PX | [3 1] | 4 | |
| | XP | [1 3] | 4 | |
| | PXS | [3 2] | 5 | |
| | SXP | [2 3] | 5 | |
| | PSX | [4 1] | 5 | |
| | XSP | [1 4] | 5 | |
| | PXP | [3 3] | 6 | |
| | PSXS | [4 2] | 6 | |
| | SXSP | [2 4] | 6 | |
| | PSXP | [4 3] | 7 | |
| | PXSP | [3 4] | 7 | |
| | PSXSP | [4 4] | 8 | |
| These permutations are | XM | [1 1 1] | 2 | 1 |
| generated by the Design | MX | | | |
| Model “Inter Exchange” | XMM | [1 1 2] | | 2 |
| 228. Note that the | MMX | | | |
| permutations are paired | XMMM | [1 1 3] | | 3 |
| because the Design Model | MMMX | | | |
| is reversible. Note that the | SXM | [2 1 1] | 3 | 1 |
| repeats of the | MXS | | | |
| inter-exchange | XMS | [1 2 1] | | |
| SDH item ‘M’ result in | SMX | | | |
| additional permutations. | SXMM | [2 1 2] | | 2 |
| This decision point is | MMXS | | | |
| shown last in the vector. | XMMS | [1 2 2] | | |
| | SMMX | | | |
| | SXMMM | [2 1 3] | | 3 |
| | MMMXS | | | |
| | XMMMS | [1 2 3] | | |
| | SMMMX | | | |
| | SXMS | [2 2 1] | 4 | 1 |
| | SMXS | | | |
| | PXM | [3 1 1] | | |
| | MXP | | | |
| | XMP | [1 3 1] | | |
| | PMX | | | |
| | SXMMS | [2 2 2] | | 2 |
| | SMMXS | | | |
| | PXMM | [3 1 2] | | |
| | MMXP | | | |
| | XMMP | [1 3 2] | | |
| | PMMX | | | |
| | SXMMMS | [2 2 3] | | 3 |
| | SMMMXS | | | |
| | PXMMM | [3 1 3] | | |
| | MMMXP | | | |
| | XMMMP | [1 3 3] | | |
| | PMMMX | | | |
| | PXMS | [3 2 1] | 5 | 1 |
| | SMXP | | | |
| | SXMP | [2 3 1] | | |
| | PMXS | | | |
| | PSXM | [4 1 1] | | |
| | MXSP | | | |
| | XMSP | [1 4 1] | | |
| | PSMX | | | |
| | PXMMS | [3 2 2] | | 2 |
| | SMMXP | | | |
| | SXMMP | [2 3 2] | | |
| | PMMXS | | | |
| | PSXMM | [4 1 2] | | |
| | MMXSP | | | |
| | XMMSP | [1 4 2] | | |
| | PSMMX | | | |
| | PXMMMS | [3 2 3] | | 3 |
| | SMMMXP | | | |
| | SXMMMP | [2 3 3] | | |
| | PMMMXS | | | |
| | PSXMMM | [4 1 3] | | |
| | MMMXSP | | | |
| | XMMMSP | [1 4 3] | | |
| | PSMMMX | | | |
| | PXMP | [3 3 1] | 6 | 1 |
| | PMXP | | | |
| | PSXMS | [4 2 1] | | |
| | SMXSP | | | |
| | SXMSP | [2 4 1] | | |
| | PSMXS | | | |
| | PXMMP | [3 3 2] | | 2 |
| | PMMXP | | | |
| | PSXMMS | [4 2 2] | | |
| | SMMXSP | | | |
| | SXMMSP | [2 4 2] | | |
| | PSMMXS | | | |
| | PXMMMP | [3 3 3] | | 3 |
| | PMMMXP | | | |
| | PSXMMMS | [4 2 3] | | |
| | SMMMXSP | | | |
| | SXMMMSP | [2 4 3] | | |
| | PSMMMXS | | | |
| | PSXMP | [4 3 1] | 7 | 1 |
| | PMXSP | | | |
| | PXMSP | [3 4 1] | | |
| | PSMXP | | | |
| | PSXMMP | [4 3 2] | | 2 |
| | PMMXSP | | | |
| | PXMMSP | [3 4 2] | | |
| | PSMMXP | | | |
| | PSXMMMP | [4 3 3] | | 3 |
| | PMMMXSP | | | |
| | PXMMMSP | [3 4 3] | | |
| | PSMMMXP | | | |
| | PSXMSP | [4 4 1] | 8 | 1 |
| | PSMXSP | | | |
| | PSXMMSP | [4 4 2] | | 2 |
| | PSMMXSP | | | |
| | PSXMMMSP | [4 4 3] | | 3 |
| | PSMMMXSP | | | |

At block 330 each permutation for each relevant Product Model is compared against the local network inventory 110 to find a trail between the required start and end nodes that consists of network infrastructure that matches the Design Items in the permutation.

Hubbing

Evaluation proceeds from both ends of the design towards the middle.

Steps that would take the design further away from the core of the network are eliminated by the use of business rules 90 known as “hubbing rules”. Nodes are categorised as to their level of importance in the carrier's network, and there are restrictions about how the levels can be traversed at each step. In general, it is illegal to take a step from a higher level node to a lower level node.

The nodes in the example network are categorised as Periphery, Local Exchange and Main Exchange. Hubbing rules in this example only allow the following steps:

Periphery→:Periphery, Local Exchange or Main Exchange

Local Exchange→Local Exchange or Main Exchange

Main Exchange→Main Exchange

The decision of which end to concentrate on at any given step is also determined by the relative hubbing level of the nodes. It is preferred to try to ‘path’ from the lower level node at each step.

Pathing

For example, if we consider the permutation SXS (SDH—Cross-Connect—SDH) for a service design request between NodeB and Nodel:
The algorithm chooses which end to start from based on the hubbing level and possibly other heuristics (which might affect the efficiency of the algorithm but not its end result). In this case it arbitrarily chooses the Z end to start from.
The Z end of the permutation is evaluated from Nodel. There are three choices from here that match the requirement to use SDH transport: NodeF, NodeH and NodeJ. NodeJ, however, can be eliminated because it represents a step from a Local Exchange node to a Periphery node, which is disallowed by the hubbing table. The two remaining options will then be evaluated in turn via the steps below.
Based on the physical location of the nodes (remaining distance to the other end), NodeH is evaluated first. This time the algorithm decides to start from the A end of the permutation, i.e. find SDH transport from NodeB. There is no SDH transport that goes directly from NodeB to NodeH, so because this was the only remaining transport item left in the permutation, this attempt fails.
NodeF is evaluated next. Again, starting from the A end of the permutation, we find an SDH transport that connects NodeB with NodeF.
The remaining Design Item X can now be satisfied, requiring a cross-connect network element to be present between the two SDH transports. Such a network element exists at NodeF, so we now know that an end-to-end path satisfying the permutation exists between the specified A and Z end nodes.

Validation

At block 340, the particular permutation of the product model resulting from the comparison process of block 330 is then validated against the local network inventory 110.

This validation primarily consists of finding suitable capacity in the network infrastructure identified. In this example, suitable timeslots must be found in the two SDH subnetworks, and suitable termination points need to be found on the cross-connect network element.

The choice of resources must also conform to technology rules 80—for example, the cross-connections between timeslots and termination points that are possible within a given network element type.

Assuming the validation process is satisfied, this gives the resultant service design 120. If the validation process fails, then the process of matching the permutation to the network continues until all possible combinations of network infrastructure between the specified A and Z end nodes, that conform to the hubbing rules and the Design Items in the permutation, have been exhausted. Flow then returns to block 330 to identify the next permutation satisfying the comparison process.

If and when the validation succeeds, the service design plan 120 is constructed using the infrastructure objects identified and the capacity that is to be consumed across that infrastructure (eg. the timeslots and termination points). That capacity is reserved in the network inventory 100 to ensure it is not taken by a subsequent design.

Computer Hardware Implementation

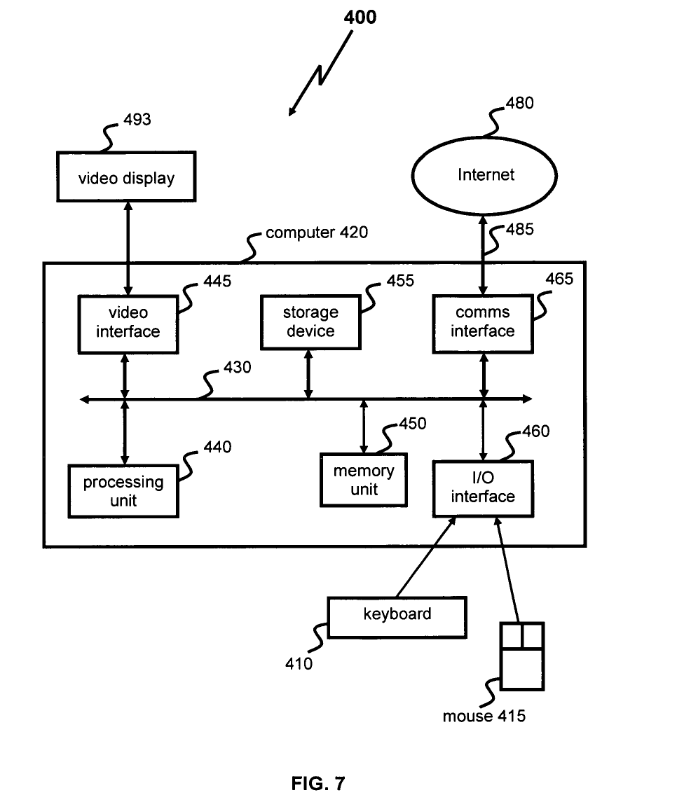

FIG. 7 shows a schematic block diagram of a computer system 400 that can be used to practice the methods described herein. More specifically, the computer system 400 is provided for executing computer software that is programmed to produce service designs for a communications network in response to a provisioning order. The computer software executes under an operating system such as MS Windows 2000, MS Windows XP™ or Linux™ installed on the computer system 400.

The computer software involves a set of programmed logic instructions that may be executed by the computer system 400 for instructing the computer system 400 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code, that perform particular steps of the methods described hereinbefore.

The components of the computer system 400 comprise: a computer 420, input devices 410, 415 and a video display 490. The computer 420 comprises: a processing unit 440, a memory unit 450, an input/output (I/O) interface 460, a communications interface 465, a video interface 445, and a storage device 455. The computer 420 may comprise more than one of any of the foregoing units, interfaces, and devices.

The processing unit 440 may comprise one or more processors that execute the operating system and the computer software executing under the operating system. The memory unit 450 may comprise random access memory (RAM), read-only memory (ROM), flash memory and/or any other type of memory known in the art for use under direction of the processing unit 440.

The video interface 445 is connected to the video display 490 and provides video signals for display on the video display 490. User input to operate the computer 420 is provided via the input devices 410 and 415, comprising a keyboard and a mouse, respectively. The storage device 455 may comprise a disk drive or any other suitable non-volatile storage medium.

Each of the components of the computer 420 is connected to a bus 430 that comprises data, address, and control buses, to allow the components to communicate with each other via the bus 430.

The computer system 400 may be connected to one or more other similar computers via the communications interface 465 using a communication channel 485 to a network 480, represented as the Internet.

The computer software program may be provided as a computer program product, and recorded on a portable storage medium. In this case, the computer software program is accessible by the computer system 400 from the storage device 455. Alternatively, the computer software may be accessible directly from the network 480 by the computer 420. In either case, a user can interact with the computer system 400 using the keyboard 410 and mouse 415 to operate the programmed computer software executing on the computer 420.

The computer system 400 has been described for illustrative purposes. Accordingly, the foregoing description relates to an example of a particular type of computer system such as a personal computer (PC), which is suitable for practicing the methods and computer program products described hereinbefore. Those skilled in the computer programming arts would readily appreciate that alternative configurations or types of computer systems may be used to practice the methods and computer program products described hereinbefore.

Embodiments of methods, systems and computer program products have been described hereinbefore relating to the comparison of standard and deployed program code to generate code change descriptions. The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

Where specific features, elements and steps referred to herein have known equivalents in the art to which the invention relates, such known equivalents are deemed to be incorporated herein as if individually set forth. Furthermore, features, elements and steps referred to in respect of particular embodiments may optionally form part of any of the other embodiments unless stated to the contrary.

We claim:

1. A method for producing a service design for a communications network in response to a provisioning order specifying a change to the network between a start node and an end node and at least one condition attaching to that change, the method comprising the steps of:
selecting a design model satisfying said at least one condition, the design model including at least information on design items related to the network resources;
determining all design permutations of the design items of the selected design model;
preferentially ranking the design permutations ; and
comparing each ranked design permutation in turn against a network model to find a permutation matching the specified start and end nodes, the matching design permutation then becoming the service design.

2. A method as claimed in claim 1, wherein the comparing step selects the first matching design permutation.

3. A method as claimed in claim 2, wherein said permutations are ranked according to the decision points in each design item.

4. A method as claimed in claim 3, wherein said ranking is performed by an explode sequence operation and sequential ordering of permutations as they arise during said explode sequence operation.

5. A method as claimed in claim 2, wherein design permutations that do not satisfy predetermined network rules are excluded.

6. A method as claimed in claim 1, wherein said design model exists within a set of predetermined such models.

7. A method as claimed in claim 1, comprising the further step of comparing the matching design permutation against capacity of said network, and accepting the matching design permutation as the service design only if said network capacity is not exceeded.

8. A computer system for producing a service design for a communications network in response to a provisioning order specifying a change to the network between a start node and an end node and at least one condition attaching to that change, the system comprising:
a memory store storing a plurality of design model; and
a processor to select a said design model satisfying said at least one condition, the design model including at least information on design items related to the network resource, determine all design permutations of the design items of the selected design model, preferentially rank the design permutations, and compare each ranked design permutation in turn against a network model to find a permutation matching the specified start and end nodes, the matching design permutation then becoming the service design.

9. A system as claimed in claim 8, wherein the processor selects the first matching design permutation in performing the comparison.

10. A system as claimed in claim 9, wherein said permutations are ranked according to the decision points in each design item.

11. A system as claimed in claim 10, wherein said processor performs the ranking by an explode sequence operation.

12. A system as claimed in claim 9, wherein design permutations that do not satisfy predetermined network rules stored in said memory are excluded by said processor.

13. A system as claimed in claim 8, wherein said design model exists within a set of predetermined such models stored in said memory.

14. A method as claimed in claim 8, wherein said processor further compares the matching design permutation against capacity of said network, and accepts the matching design permutation as the service design only if said network capacity is not exceeded.

15. A computer program product comprising a storage medium storing a computer program, said program, when executing on a computer, producing a service design for a communications network in response to a provisioning order specifying a change to the network between a start node and an end node and at least one condition attaching to that change, and including code means for:
selecting a design model satisfying said at least one condition, the design model including at least information on design items related to the network resources;
determining all design permutations of the design items of the selected design model;
preferentially ranking the design permutations; and comparing each ranked design permutation in turn against a network model to find a permutation matching the specified start and end nodes, the matching design permutation then becoming the service design.
